(19) United States
(12) Patent Application Publication
(10) Pub. No.: US 2023/0292936 A1
(43) Pub. Date: Sep. 21, 2023

(54) A DISPENSER FOR CONTACTLESS EJECTION OF DISPOSABLE CUPS OR LIDS

(71) Applicant: "KRAM FC" SPOLKA Z OGRANICZONA ODPOWIEDZIALNOSCIA, Dzierzgon (PL)

(72) Inventor: Piotr Gluszyk, Paslek (PL)

(21) Appl. No.: 18/019,805

(22) PCT Filed: Aug. 3, 2021
(86) PCT No.: PCT/PL2021/050057

§ 371 Date: Feb. 4, 2023

(30) Foreign Application Priority Data
Aug. 4, 2020 (PL) P.434898
Dec. 22, 2020 (PL) P.436446

(51) Int. Cl. A47F 1/10; B65G 59/10

(52) U.S. Cl. CPC A47F 1/106; B65G 59/108

(57) ABSTRACT

A dispenser for contactless ejection of disposable cups or lids consisting of a mechanism feeding the cups or lids, above which it has a hopper for the cups or cups lids, while below it has a handle supporting the cup or lid and it has a proximity sensor for activating the mechanism feeding the cups or lids, characterised in that the mechanism feeding the cups has at least one plate which has at least two pairs of rotary separators distributed on the circumference of the opening for the cup, in the form of rollers seated on axles positioned in at least one plate and propelled by a motor, where the first part of the rotary separators rotates in the opposite direction to the direction of rotation of the second part of the rotary separators.

The object of the invention is a dispenser for contactless ejection of disposable cups meant for their filling or lids for cups.

From the patent description U.S. Pat. No. 8,297,471 B2 there is a known interactive manual dispenser of cups. The invention comprises a decorative casing comprising a housing placed between the first and the second cover, at least one switching mechanism, a control circuit and at least one active element, including light elements, motor elements, scent dispensers and/or audio elements. The decorative cover also comprises an opening along one end. One or more switching mechanisms are placed along the first cover neighbouring the opening. The functionality of the switching mechanisms comprises direct contact, indirect contact and the lack of contact between a bowl and an optical or mechanical switch. The control circuit may be placed on a printed circuit board and it controls the functionality of the active elements. The active elements are attached to the decorative cover and activated when the cup comes into interaction with at least one switching mechanism.

From the description of the invention CA2691958A1 there is a known dispenser of cups having multiple elastic, adjustable clamps for coupling and dispensing the cups without damaging the surface of the cups being dispensed. The clips comprise a cup coupling part, which exceeds the deformed width of the part of the mug with which the clips are coupled.

From the description of the invention GB2173777A there is a known dispenser of cups, in particular for dispensing foam cups individually from a stack of cups, which usually would be a vertical stack comprising multiple cam bodies (28), each of which has a cam surface (32) being a spiral around the axis (31) of the body, each body having a helically projecting protrusion or bulge (33) around the body; the lower surface (32B) of the protrusion or bulge constitutes an extension of the cam surface (32A) in order to provide an increased cam surface in order to ensure stronger coupling of the cam surface with the bowl rim than the one presented by the body itself. The dimensions of the foot are selected for easy forming. The improved cam profile has mutually coupled surfaces between a bearing shelf (50) and the upper side wall of the bowl, and an increased separation of the shelf (50) and the surface of the dispensing cam (32A).

From the description of the invention GB2402386 there is a known dispenser of cups comprising a plurality of dispensing mechanisms for dispensing cups from the respective plurality of nested cups, each said mechanism comprising four or more coils splitting the cups 18, 20, defining a circular cup dispensing opening, and in which the neighbouring dispensing mechanisms are tightly distributed inside the dispenser, so that the shortest distance between the adjacent cup dispensing openings is approximately 25 mm or less. The dispenser is usually a cup dispenser of the carousel type, in which cup dispensing mechanisms are placed around the cup positioning stations of the cup dispenser of a carousel type in a limited space, in this manner reducing the size of the carousel and/or enabling a wider choice of beverages in a predetermined space. The functions enabling close distribution of the mechanisms include positioning the coils 18,20 in a trapezoidal configuration, with the inner coils 20 closer to each other than the outside 20; having cam sections with various strokes on each coil and having toothless segments between the coils on a toothed wheel rim 30 which propels them.

The essence of the invention is a dispenser for contactless ejection of disposable cups or lids consisting of a mechanism feeding the cups or lids, above which it has a hopper for the cups or lids for cups, while below it has a handle supporting the cup or lid and it has a proximity sensor for activating the mechanism feeding the cups or lids, characterised in that the mechanism feeding the cups has at least one plate, which has at least two pairs of rotary separators distributed on the circumference of the opening for the cup, in the form of rollers seated on axles positioned in at least one plate and propelled by a motor, where the first part of the rotary separators rotates in the opposite direction to the direction of rotation of the second part of the rotary separators.

Preferably, the rotary separators have drive wheels.

Preferably, the mechanism for feeding the cups has two plates parallel with respect to each other: upper and lower, between which, on the circumference of the opening for the cup, it has at least two distributed pairs of rotary separators, in the form of rollers seated on axles positioned in a part of the lower plate and the upper plate with exposed drive wheels.

Preferably, the propulsion from the motor is transmitted to the drive wheels by means of a gear train.

Preferably, the drive wheels are surrounded alternately from the inside and the outside by a drive belt.

Preferably, the drive wheels constitute gear wheels surrounded alternately from the inside and the outside by a drive belt.

Preferably, the drive belt is toothed on both sides.

Preferably, the pairs of rotary separators in the form of cylindrical rollers have on their external surface grooves in the shape of the letter “U” along a helix with the angle α, while the depth and the width of the grooves correspond to the shapes of the folding edge of the rim of the cups.

Preferably, for cups with a rim diameter of up to 60 mm, it has two pairs of separators, for cups with a rim diameter of 60 to 100 mm it has four pairs of separators, and for cups with a rim diameter of more than 100 mm it has five pairs of separators.

Preferably, the adjustable torque on the separators depends on the type of the cup being separated and the degree of its jamming in the adjacent cup.

Preferably, the height of the separators exceeds the average distance between the edges of the cups in the stack which depends on the gaps between the cups, so that during one full rotation of the separators the cup with the lowest position would be separated from the stack, while holding the remaining cups.

Preferably, the direction of inclination of the helix of the groove notches of the rotary separators in pairs is right and left-handed.

Preferably, the angle of inclination of the helix (α) of the groove notch of the rotary separators is 5 to 45°.

Preferably, for cups without a double wall, with a rim diameter of up to 100 mm and the distance between the rims in a stack of up to 5 mm, the angle of inclination of the helix (α) of the groove notch of the rotary separators is 5°, and for cups with a double wall, where the distances between the rims of the cups in the stack are above 5 mm for a diameter of these cups exceeding 100 mm, the angle of inclination of the helix (α) of the groove notch of the rotary separators is 45°.

Preferably, the diameter of the rotary separators ranges from 30 to 60 mm depending on the size of the cup.

Preferably, for a rim diameter of the cups of up to 60 mm the diameter of the separators ranges from 30 to 40 mm, for a rim diameter of the cups of 60 to 100 mm the diameter of the separators ranges from 40 to 50 mm, and for a rim diameter of the cups exceeding 100 mm the diameter of the separators ranges from 50 to 60 mm.

Preferably, the proximity sensor constitutes an optical sensor, an ultrasound sensor, a capacitive sensor, an infrared radiation sensor, an inductive sensor. The dispenser may also use any sensor adapted to detect an object (e.g. a hand) at a small distance from the sensor (i.e. with no need for physical contact).

Preferably, the rotary separators from the first and second part of the rotary separators are distributed alternately on the circumference of the opening for the cup.

Preferably, the rotary separators from the first and second part of the rotary separators are distributed in at least two groups on the circumference of the opening for the cup.

Preferably, the pairs of separators on the circumference of the outer plane have shaped grooves in opposite directions relative to each other, along the helices, below which they have a conical circumferential inclination similar to the shape of the outer surface of the cup. The conical circumferential inclination constitutes the value of inclination of the cup. The conical circumferential inclination constitutes a strip along the lower part of the groove with a width similar to the width of the groove. The pairs of the rotary separators have openings for locking the positioning.

The pairs of separators have varying diameters along their height, wherein on the circumference of the larger external diameter they have shaped grooves in opposite directions relative to each other, along the helices, while in the lower part they have a protrusion, which constitutes a replaceable element partially protruding on a part of the circumference of the larger external diameter of the separators and has in its lower part a fastening element and at least one fixing pin. The protrusion has thickness similar to the distance between the lids. The height of the larger external diameter of the pair of separators constitutes from 0.20 to 0.5 of the entire height of the separators.

The solution according to the invention allows for contactless feeding of disposable cups regardless of the material from which they are made. The stack of cups is inserted from the top into a guiding casing, from which the individual cups become separated. The applied proximity sensor, preferably placed under the cup feeding mechanism as a result of an arm movement, activates the mechanism of feeding a single cup. Every movement in the field of observation of the proximity sensor allows for separation of a single cup by means of a set of rotary separators, which lower a single cup onto a supporting handle, from which it can be removed without contact with the remaining cups. The use of a larger number of separators prevents the deformation of the cup during separation. The solution according to the invention allows for separation of disposable cups, which tend to mutually jam during transport in stacks, and in particular this solution is applicable to paper cups with a double wall. It also allows for separating and feeding the jammed cups without damaging them. In the case of separators rotating in the same direction, a problem arises that the entire stack would rotate, and the last cup would not exit the stack, since the remaining cups in the stack which are rotated push it out of the separating groove. Due to the use of separators rotating in opposite directions, the stack of cups does not rotate. The rotations of separators rotating left are compensated by separators rotating right, and, as a result, the stack of cups does not rotate, while the rotating separators “pull” the last cup down, by engaging the edge of the cup with the groove. The additional invention allows for contactless ejection of disposable cups which are precisely separated from the cups in the stack without uncontrolled lateral tilting. It also enables contactless ejection of cup lids.

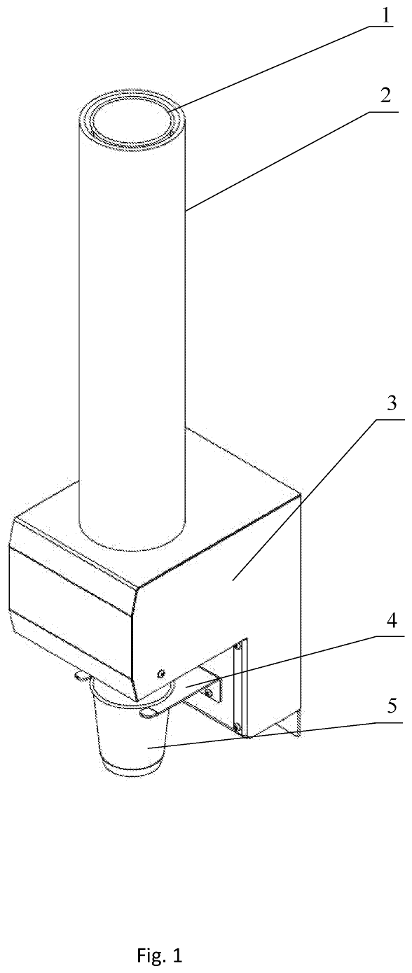

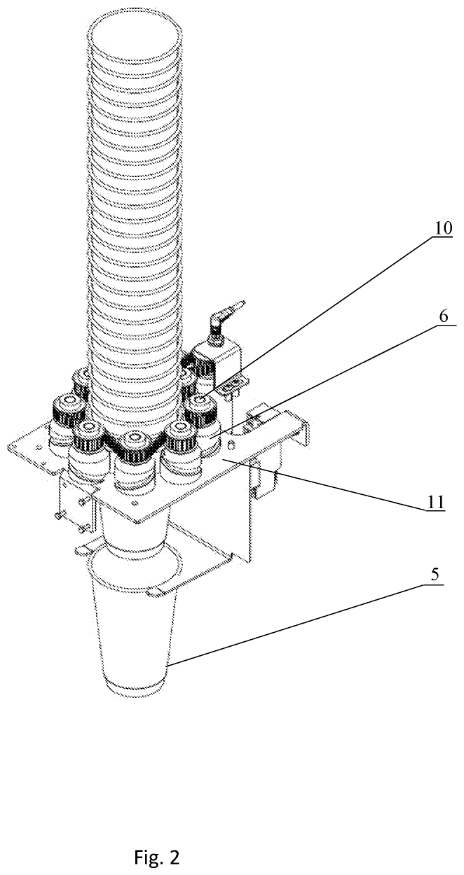

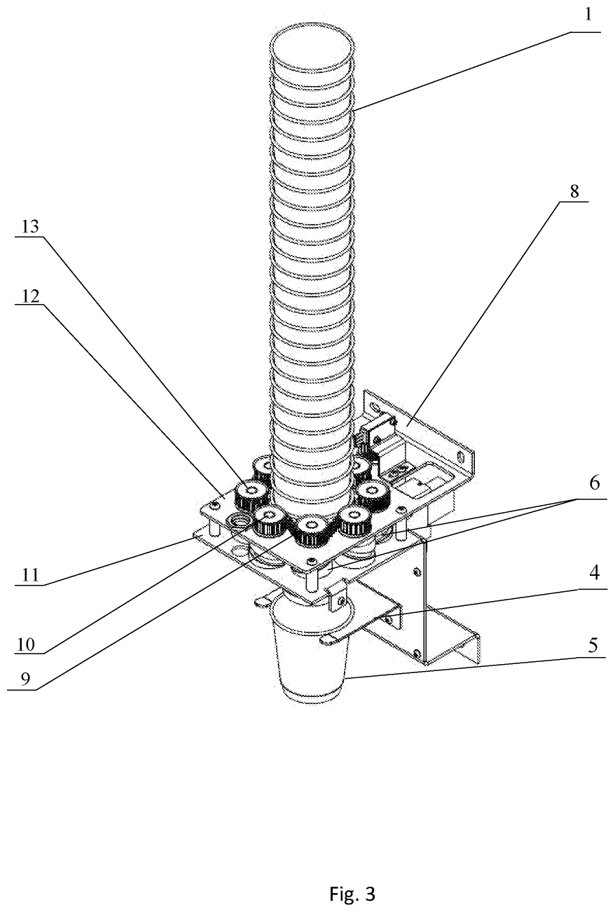

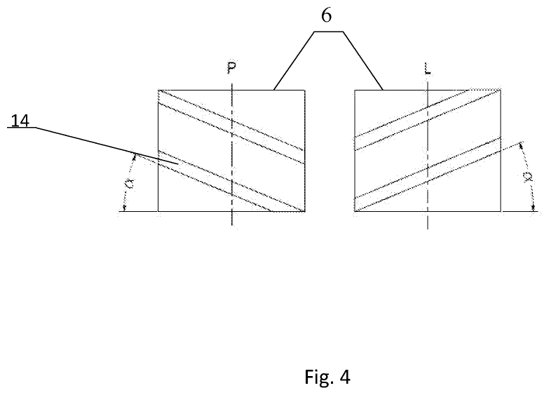

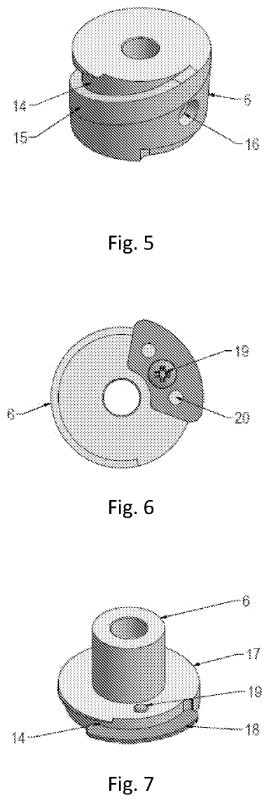

The object of the invention is presented in the drawing, where FIG. 1 presents the dispenser in an axonometric view, FIG. 2 presents the dispenser with one plate in an axonometric view with visible propulsion of the separators, FIG. 3 presents the dispenser with two plates in an axonometric view with visible propulsion of the separators, FIG. 4 presents an arrangement of separators in a front view, FIG. 5 presents the separator in an axonometric view, FIG. 6 presents the separator for lids in a bottom view with a visible replaceable protrusion, FIG. 7 presents the separator for lids in an axonometric view.

### EMBODIMENT I

In the embodiment, the dispenser for contactless ejection of disposable cups consists of a mechanism feeding the cups, above which it has a hopper for the cups, while below it has a handle supporting the cup and it has a proximity sensor for activating the mechanism feeding the cups. The mechanism 3 feeding the cups 5 has one plate 11, which on the circumference of the opening for the cup 5 has two distributed pairs of rotary separators 6 in the form of rollers seated on axles 10 positioned in the plate 11 and propelled by the motor, where the first part of the rotary separators 6 rotates in a direction opposite the direction of rotation of the second part of the rotary separators 6.

### EMBODIMENT II

In the embodiment, the dispenser for contactless ejection of disposable cups consists of a mechanism feeding the cups, above which it has a hopper for the cups, while below it has a handle supporting the cup and it has a proximity sensor for activating the mechanism feeding the cups. The mechanism 3 feeding the cups 5 has one plate 11, which on the circumference of the opening for the cup 5 has two distributed pairs of rotary separators 6 in the form of rollers seated on axles 10 positioned in the plate 11 and propelled by the motor, where the first part of the rotary separators 6 rotates in a direction opposite the direction of rotation of the second part of the rotary separators 6. The rotary separators 6 have drive wheels 13.

### EMBODIMENT III

In the embodiment, the dispenser for contactless ejection of disposable cups consists of a mechanism feeding the cups, above which it has a hopper for the cups, while below it has a handle supporting the cup and it has a proximity sensor for activating the mechanism feeding the cups. The mechanism 3 for feeding the cups 5 has two plates parallel with respect to each other: upper 12 and lower 11, between which, on the circumference of the opening for the cup 5, it has two distributed pairs of rotary separators 6, in the form of rollers seated on axles 10 positioned in a part of the lower plate 11 and the upper plate 12 with exposed drive wheels 13 and propelled by the motor, where the first part of the rotary separators 6 rotates in a direction opposite the direction of rotation of the second part of the rotary separators 6.

### EMBODIMENT IV

In the embodiment, the dispenser for contactless ejection of disposable cups consists of a mechanism feeding the cups, above which it has a hopper for the cups, while below it has a handle supporting the cup and it has a proximity sensor for activating the mechanism feeding the cups. The mechanism 3 feeding the cups 5 has one plate 11, which on the circumference of the opening for the cup 5 has two distributed pairs of rotary separators 6 in the form of rollers seated on axles 10 positioned in the plate 11 and propelled by the motor, where the first part of the rotary separators 6 rotates in a direction opposite the direction of rotation of the second part of the rotary separators 6. The rotary separators 6 have drive wheels 13. The propulsion from the motor is transmitted to the drive wheels 13 by means of a gear train.

### EMBODIMENT V

In the embodiment, the dispenser for contactless ejection of disposable cups consists of a mechanism feeding the cups, above which it has a hopper for the cups, while below it has a handle supporting the cup and it has a proximity sensor for activating the mechanism feeding the cups. The mechanism 3 feeding the cups 5 has one plate 11, which on the circumference of the opening for the cup 5 has two distributed pairs of rotary separators 6 in the form of rollers seated on axles 10 positioned in the plate 11 and propelled by the motor, where the first part of the rotary separators 6 rotates in a direction opposite the direction of rotation of the second part of the rotary separators 6. The rotary separators 6 have drive wheels 13. The propulsion from the motor is transmitted to the drive wheels 13 by means of a gear train. The pairs of rotary separators 6 in the form of cylindrical rollers have grooves 14 on the outer surface along a helix with the angle α.

### EMBODIMENT VI

In the embodiment, the dispenser for contactless ejection of disposable cups consists of a mechanism feeding the cups, above which it has a hopper for the cups, while below it has a handle supporting the cup and it has an optical proximity sensor for activating the mechanism feeding the cups. The mechanism 3 for feeding cups 5 has two plates parallel with respect to each other: upper 12 and lower 11, between which, on the circumference of the opening for the cup 5, it has two distributed pairs of rotary separators 6, in the form of rollers seated on axles 10 positioned in a part of the lower plate 11 and the upper plate 12 with exposed drive wheels 13 and propelled by the motor, where the first part of the rotary separators 6 rotates in a direction opposite the direction of rotation of the second part of the rotary separators 6. The rotary separators 6 have drive wheels 13, which are surrounded alternately from the inside and the outside by a V-shaped drive belt 9.

### EMBODIMENT VII

In the embodiment, the dispenser for contactless ejection of disposable cups consists of a mechanism feeding the cups, above which it has a hopper for the cups, while below it has a handle supporting the cup and it has an ultrasound proximity sensor for activating the mechanism feeding the cups. The mechanism 3 feeding the cups 5 has one plate 12, which on the circumference of the opening for the cup 5 has two distributed pairs of rotary separators 6 in the form of rollers seated on axles 10 positioned in the plate 12 and propelled by the motor, where the first part of the rotary separators 6 rotates in a direction opposite the direction of rotation of the second part of the rotary separators 6. The rotary separators 6 have drive wheels 13. The propulsion from the motor is transmitted to the drive wheels 13 by means of a gear train. The drive wheels 13 constitute gears surrounded alternately from the inside and the outside by a drive belt 9 toothed on both sides. The pairs of rotary separators 6 in the form of cylindrical rollers have on their external surface grooves 14 in the shape of the letter “U” along a helix with the angle α, while the depth and the width of the grooves correspond to the shapes of the folding edge of the rim of the cups 5. The height of the separators 6 exceeds the average distance between the edges of the cups in the stack. The direction of inclination of the helix of the groove notches 14 of the rotary separators 6 in pairs is right and left-handed.

### EMBODIMENT VIII

In the embodiment, the dispenser for contactless ejection of disposable cups consists of a mechanism feeding the cups, above which it has a hopper for the cups, while below it has a handle supporting the cup and it has a capacitive proximity sensor for activating the mechanism feeding the cups. The mechanism 3 feeding the cups 5 has one plate 11, which on the circumference of the opening for the cup 5 has two distributed pairs of rotary separators 6 in the form of rollers seated on axles 10 positioned in the plate 11 and propelled by the motor, where the first part of the rotary separators 6 rotates in a direction opposite the direction of rotation of the second part of the rotary separators 6. The rotary separators 6 have drive wheels 13. The propulsion from the motor is transmitted to the drive wheels 13 by means of a gear train. The drive wheels 13 constitute gears surrounded alternately from the inside and the outside by a drive belt 9 toothed on both sides. The pairs of rotary separators 6 in the form of cylindrical rollers have on their external surface grooves 14 in the shape of the letter “U” along a helix with the angle α, while the depth and the width of the grooves correspond to the shapes of the folding edge of the rim of the cups 5. For cups with a rim diameter of up to 60 mm, it has two pairs of separators 6 with a diameter of 35 mm. The adjustable torque on the separators 6 depends on the type of the cup 5 being separated and the degree of its jamming in the adjacent cup 5. The height of the separators 6 constitutes an average distance between the edges of the cups in the stack, increased by 1 mm. The angle of inclination of the helix (α) of the groove notch 14 of the rotary separators 6 is 5°.

### EMBODIMENT IX

In the embodiment, the dispenser for contactless ejection of disposable cups consists of a mechanism feeding the cups, above which it has a hopper for the cups, while below it has a handle supporting the cup and it has an infrared radiation proximity sensor for activating the mechanism feeding the cups. The mechanism 3 feeding the cups 5 has one plate 12, which on the circumference of the opening for the cup 5 has two distributed pairs of rotary separators 6 in the form of rollers seated on axles 10 positioned in the plate 12 and propelled by the motor, where the first part of the rotary separators 6 rotates in a direction opposite the direction of rotation of the second part of the rotary separators 6. The rotary separators 6 have drive wheels 13. The propulsion from the motor is transmitted to the drive wheels 13 by means of a gear train. The drive wheels 13 constitute gears surrounded alternately from the inside and the outside by a drive belt 9 toothed on both sides. The pairs of rotary separators 6 in the form of cylindrical rollers have on their external surface grooves 14 in the shape of the letter “U” along a helix with the angle α, while the depth and the width of the grooves correspond to the shapes of the folding edge of the rim of the cups 5. For cups with rim diameters of 60 to 100 mm, it has four pairs of separators 6 with a diameter of 45 mm. The height of the separators (6) constitutes an average distance between the edges of the cups in the stack, increased by 1.5 mm. The angle of inclination of the helix (α) of the groove notch 14 of the rotary separators 6 is 25°.

### EMBODIMENT X

In the embodiment, the dispenser for contactless ejection of disposable cups consists of a mechanism feeding the cups, above which it has a hopper for the cups, while below it has a handle supporting the cup and it has an inductive proximity sensor for activating the mechanism feeding the cups. The mechanism 3 feeding the cups 5 has one plate 12, which on the circumference of the opening for the cup 5 has two distributed pairs of rotary separators 6 in the form of rollers seated on axles 10 positioned in the plate 12 and propelled by the motor, where the first part of the rotary separators 6 rotates in a direction opposite the direction of rotation of the second part of the rotary separators 6. The rotary separators 6 have drive wheels 13. The propulsion from the motor is transmitted to the drive wheels 13 by means of a gear train. The drive wheels 13 constitute gears surrounded alternately from the inside and the outside by a drive belt 9 toothed on both sides. The pairs of rotary separators 6 in the form of cylindrical rollers have on their external surface grooves 14 in the shape of the letter “U” along a helix with the angle α, while the depth and the width of the grooves correspond to the shapes of the folding edge of the rim of the cups 5. For cups with a rim diameter of above 100 mm, it has five pairs of separators 6 with a diameter of 55 mm. The height of the separators 6 exceeds the average distance between the edges of the cups in the stack. The height of the separators 6 constitutes an average distance between the edges of the cups in the stack, increased by 2 mm. The angle of inclination of the helix (α) of the groove notch 14 of the rotary separators 6 is 45°. The rotary separators from the first and second part of the rotary separators are distributed alternately on the circumference of the opening for the cup 5. The rotary separators from the first and second part of the rotary separators are distributed in at least two groups on the circumference of the opening for the cup 5.

### EMBODIMENT XI

In the embodiment, the dispenser for contactless ejection of disposable cups according to the application P.434898 of 4 Aug. 2020 consists of a mechanism for feeding the cups s, above which it has a hopper for the cups, while below it has a handle supporting a cup and it has a proximity sensor for activating the mechanism feeding the cups, and it has pairs of rotary separators 6 in the form of rollers seated on axles positioned in at least one plate and propelled by a motor, where the first part of the rotary separators rotates in a direction opposite to the direction of rotation of the second part of the rotary separators 6. The pairs of separators 6 on the circumference of the outer diameter have shaped grooves 14 in opposite directions relative to each other, along the helices, below which they have a conical circumferential inclination 15 similar to the shape of the outer surface of the cup.

### EMBODIMENT XII

In the embodiment, the dispenser for contactless ejection of disposable cups according to the application P.434898 of 4 Aug. 2020 consists of a mechanism for feeding the cups, above which it has a hopper for the cups, while below it has a handle supporting a cup and it has a proximity sensor for activating the mechanism feeding the cups, and it has pairs of rotary separators 6 in the form of rollers seated on axles positioned in at least one plate and propelled by a motor, where the first part of the rotary separators rotates in a direction opposite to the direction of rotation of the second part of the rotary separators 6. The pairs of separators 6 on the circumference of the outer diameter have shaped grooves 14 in opposite directions relative to each other, along the helices, below which they have a conical circumferential inclination 15 similar to the shape of the outer surface of the cup. The conical circumferential inclination 15 constitutes the value of inclination of the cup. The conical circumferential inclination 15 constitutes a strip along the lower part of the groove 14 with a width similar to the width of the groove 14. The pairs of the rotary separators 6 have openings 16 for locking the positioning.

In the embodiment, the dispenser for contactless ejection of disposable lids according to the application P.434898 of 4 Aug. 2020 consists of a mechanism for feeding the lids, above which it has a hopper for the cup lids, while below it has a handle supporting a lid and it has a proximity sensor for activating the mechanism feeding the lids, and it has pairs of rotary separators 6 in the form of rollers seated on axles positioned in at least one plate and propelled by a motor, where the first part of the rotary separators rotates in a direction opposite to the direction of rotation of the second part of the rotary separators 6. The pairs of separators 6 have varying diameters along their height, wherein on the circumference of the larger external diameter 17 they have shaped grooves 14 in opposite directions relative to each other, along the helices, while in the lower part they have a protrusion 18.

### EMBODIMENT XIV

In the embodiment, the dispenser for contactless ejection of disposable lids according to the application P.434898 of 4 Aug. 2020 consists of a mechanism for feeding the lids, above which it has a hopper for the cup lids, while below it has a handle supporting a lid and it has a proximity sensor for activating the mechanism feeding the lids, and it has pairs of rotary separators 6 in the form of rollers seated on axles positioned in at least one plate and propelled by a motor, where the first part of the rotary separators rotates in a direction opposite to the direction of rotation of the second part of the rotary separators 6. The pairs of separators 6 have varying diameters along their height, wherein on the circumference of the larger external diameter 17 they have shaped grooves 14 in opposite directions relative to each other, along the helices, while in the lower part they have a protrusion 18, which constitutes a replaceable element partially protruding on a part of the circumference of the larger external diameter 17 of the separators 6.

### EMBODIMENT XV

In the embodiment, the dispenser for contactless ejection of disposable lids according to the application P.434898 of 4 Aug. 2020 consists of a mechanism for feeding the lids, above which it has a hopper for the cup lids, while below it has a handle supporting a lid and it has a proximity sensor for activating the mechanism feeding the lids, and it has pairs of rotary separators 6 in the form of rollers seated on axles positioned in at least one plate and propelled by a motor, where the first part of the rotary separators rotates in a direction opposite to the direction of rotation of the second part of the rotary separators 6. The pairs of separators 6 have varying diameters along their height, wherein on the circumference of the larger external diameter 17 they have shaped grooves 14 in opposite directions relative to each other, along the helices, while in the lower part they have a protrusion 18 and in the lower part they have a fastening element 19 and at least one fixing pin 20. The protrusion 18 has thickness similar to the distance between the lids. The height of the larger external diameter 17 of the pair of separators 6 constitutes 0.20 of the entire height of the separators 6.

### EMBODIMENT XVI

In the embodiment, the dispenser for contactless ejection of disposable lids according to the application P.434898 of 4 Aug. 2020 consists of a mechanism for feeding the lids, above which it has a hopper for the cup lids, while below it has a handle supporting a lid and it has a proximity sensor for activating the mechanism feeding the lids, and it has pairs of rotary separators 6 in the form of rollers seated on axles positioned in at least one plate and propelled by a motor, where the first part of the rotary separators rotates in a direction opposite to the direction of rotation of the second part of the rotary separators 6. The pairs of separators 6 have varying diameters along their height, wherein on the circumference of the larger external diameter 17 they have shaped grooves 14 in opposite directions relative to each other, along the helices, while in the lower part they have a protrusion 18 and in the lower part they have a fastening element 19 and at least one fixing pin 20. The protrusion 18 has thickness similar to the distance between the lids. The height of the larger external diameter 17 of the pair of separators 6 constitutes 0.5 of the entire height of the separators 6.

1. A dispenser for contactless ejection of disposable cups or lids consisting of a mechanism feeding the cups or lids, above which it has a hopper for the cups or cup lids, while below it has a handle supporting the cup or lid and it has a proximity sensor for activating the mechanism feeding the cups or lids, characterised in that the mechanism (3) feeding the cups (5) has at least one plate (11), which has at least two pairs of rotary separators (6) distributed on the circumference of the opening for the cup (5), in the form of rollers seated on axles (10) positioned in at least one plate (11) and propelled by a motor, where the first part of the rotary separators (6) rotates in the opposite direction to the direction of rotation of the second part of the rotary separators (6).

2. The dispenser according to claim 1, characterised in that the rotary separators (6) have drive wheels (13).

3. The dispenser according to claim 1, characterised in that the mechanism (3) for feeding the cups (5) has two plates parallel with respect to each other: upper (12) and lower (11), between which, on the circumference of the opening for the cup (5), it has at least two distributed pairs of rotary separators (6), in the form of rollers seated on axles (10) positioned in a part of the lower plate (11) and the upper plate (12) with exposed drive wheels (13).

4. The dispenser according to claim 1, characterised in that propulsion from the motor is transmitted to the drive wheels (13) by means of a gear train.

5. The dispenser according to claim 1, characterised in that the drive wheels (13) are surrounded alternately from the inside and the outside by a drive belt (9).

6. The dispenser according to claim 1, characterised in that the drive wheels (13) constitute gears surrounded alternately from the inside and the outside by the drive belt (9).

7. The dispenser according to claim 1, characterised in that the drive belt (9) is toothed on both sides.

8. The dispenser according to claim 1, characterised in that the pairs of rotary separators (6) in the form of cylindrical rollers have grooves (14) on the outer surface along a helix with the angle a.

9. The dispenser according to claim 1, characterised in that, for cups with a rim diameter of up to 60 mm, it has two pairs of separators (6), for cups with a rim diameter of 60 to 100 mm it has four pairs of separators (6), and for cups with a rim diameter of more than 100 mm it has five pairs of separators (6).

10. The dispenser according to claim 1, characterised in that it has an adjustable torque on the separators (6), which depends on the type of the cup (5) being separated and the degree of its jamming in the adjacent cup (5).

11. The dispenser according to claim 1, characterised in that the height of the separators (6) exceeds the average distance between the edges of the cups in the stack.

12. The dispenser according to claim 1, characterised in that the direction of inclination of the helix of the groove notches (14) of the rotary separators (6) in pairs is right and left-handed.

13. The dispenser according to claim 1, characterised in that the angle of inclination of the helix (a) of the groove notch (14) of the rotary separators (6) is 5 to 45°.

14. The dispenser according to claim 13, characterised in that, for cups without a double wall, with a rim diameter of up to 100 mm and the distance between the rims in a stack of up to 5 mm, the angle of inclination of the helix (a) of the groove notch (14) of the rotary separators (6) is 5°, and for cups with a double wall, where the distances between the rims of the cups in a stack are above 5 mm for a diameter of these cups exceeding 100 mm, the angle of inclination of the helix (a) of the groove notch (14) of the rotary separators (6) is 45°.

15. The dispenser according to claim 1, characterised in that the diameter of the rotary separators (6) ranges from 30 to 60 mm depending on the size of the cup (5).

16. The dispenser according to claim 15, characterised in that for a rim diameter of the cups of up to 60 mm the diameter of the separators ranges from 30 to 40 mm, for a rim diameter of the cups of 60 to 100 mm the diameter of the separators ranges from 40 to 50 mm, and for a rim diameter of the cups exceeding 100 mm the diameter of the separators ranges from 50 to 60 mm.

17. The dispenser according to claim 1, characterised in that the proximity sensor constitutes an optical sensor, an ultrasound sensor, a capacitive sensor, an infrared radiation sensor, an inductive sensor.

18. The dispenser according to claim 1, characterised in that the rotary separators from the first and second part of the rotary separators are distributed alternately on the circumference of the opening for the cup (5).

19. The dispenser according to claim 1, characterised in that the rotary separators from the first and second part of the rotary separators are distributed in at least two groups on the circumference of the opening for the cup (5).

20. The dispenser according to claim 1, characterised in that the pairs of separators (6) on the circumference of the outer diameter have shaped grooves (14) in opposite directions relative to each other, along the helices, below which they have a conical circumferential inclination (15) similar to the shape of the outer surface of the cup.

21. The dispenser according to claim 20, characterised in that the conical circumferential inclination (15) constitutes the value of inclination of the cup.

22. The dispenser according to claim 20, characterised in that the conical circumferential inclination (15) constitutes a strip along the lower part of the groove (14) with a width similar to the width of the groove (14).

23. The dispenser according to claim 20, characterised in that the pairs of the rotary separators (6) have openings (16) for locking the positioning.

24. The dispenser according to claim 20, characterised in that the pairs of separators (6) have varying diameters along their height, wherein on the circumference of the larger external diameter (17) they have shaped grooves (14) in opposite directions relative to each other, along the helices, while in the lower part they have a protrusion (18).

25. The dispenser according to claim 24, characterised in that the protrusion (18) constitutes a replaceable element partially protruding on a part of the circumference of the larger external diameter (17) of the separators (6).

26. The dispenser according to claim 24, characterised in that the protrusion (18) constituting a replaceable element has in its lower part a fastening element (19) and at least one fixing pin (20).

27. The dispenser according to claim 24, characterised in that the protrusion (18) has thickness similar to the distance between the lids.

28. The dispenser according to claim 24, characterised in that the height of the larger external diameter (17) of the pair of separators (6) constitutes from 0.20 to 0.5 of the entire height of the separators (6).
